(19) United States
(12) Patent Application Publication
(10) Pub. No.: US 2025/0185076 A1
(43) Pub. Date: Jun. 5, 2025

(54) BASE STATION APPARATUS, CONTROL METHOD, AND COMPUTER-READABLE STORAGE MEDIUM IN WHICH POSITION OF TERMINAL APPARATUS IS ESTIMATED

(71) Applicant: KDDI CORPORATION, Tokyo (JP)

(72) Inventors: Ryoichi OGASAWARA, Tokyo (JP); Masaya SHIBAYAMA, Tokyo (JP); Kazuya MORIWAKI, Tokyo (JP)

(21) Appl. No.: 19/052,960

(22) Filed: Feb. 13, 2025

Related U.S. Application Data
(63) Continuation of application No. PCT/JP2023/005170, filed on Feb. 15, 2023.

(30) Foreign Application Priority Data
Sep. 20, 2022 (JP) 2022-149507

(51) Int. Cl. H04W 74/0833; H04W 52/38

(52) U.S. Cl. CPC H04W 74/0833; H04W 52/38

(57) ABSTRACT

A base station apparatus notifies another base station apparatus of information indicating an instruction instructing that a random-access preamble transmitted by a terminal apparatus be measured for measuring a position of the terminal apparatus and a sequence to be used for transmission of the random-access preamble, designates the sequence and instructs the terminal apparatus to transmit the random-access preamble, and measures the random-access preamble transmitted by the terminal apparatus, using the sequence in order to measure the position of the terminal apparatus. The position of the terminal apparatus is estimated based on results of measurement of the random-access preamble performed by the base station apparatus and the other base station apparatus.

### CROSS-REFERENCE TO RELATED APPLICATION(S)

This application is a continuation of International Patent Application No. PCT/JP2023/005170 filed on Feb. 15, 2023, which claims priority to and the benefit of Japanese Patent Application No. 2022-149507 filed on Sep. 20, 2022, the entire disclosures of which are incorporated herein by reference.

### BACKGROUND OF THE INVENTION

### Field of the Invention

The present invention relates to a technique for estimating the position of a terminal apparatus.

### Description of the Related Art

In wireless communication systems, the position of a terminal apparatus is specified, and thereby a communication service corresponding to the position can be provided to the terminal apparatus. A terminal apparatus can specify the position thereof by measuring radio waves transmitted from an artificial satellite, using GNSS (global navigation satellite system), for example, and notify information regarding the specified position to a network via a base station apparatus. On the other hand, there may be a case where a terminal apparatus cannot use GNSS measurement, a case where a GNSS measurement function is disabled, and the like. In such cases, for example, it is possible to use a RAN (radio access network)-based position estimation technique in which a plurality of base station apparatuses measure a radio signal transmitted from the terminal apparatus, and estimate the position of the terminal apparatus based on the difference in timing when the radio waves arrive the base station apparatuses (propagation time) and directions of arrival.

In the RAN-based position estimation technique, the base station apparatus may need to be able to accurately receive a radio signal transmitted by the terminal apparatus. In this case, for example, in an OFDM (orthogonal frequency division multiple access)-based cellular communication system, if a receiving timing of a radio signal transmitted by a terminal apparatus significantly deviates from an expected timing, the orthogonality between subcarriers is not ensured, and the radio signal cannot be accurately received. On the other hand, it may be envisioned that the terminal apparatus is located at a position that is close to some of base station apparatuses that perform measurement, and is distant from the others. In such a case, by the terminal apparatus transmitting a radio signal at a timing aligned with a timing of one of those base station apparatuses, the base station apparatus can accurately receive the radio signal, but the other base station apparatuses cannot accurately receive the radio signal. For this reason, the position of the terminal apparatus cannot be accurately estimated.

### SUMMARY OF THE INVENTION

The present invention provides a technique that makes it possible to accurately estimate the position of a terminal apparatus based on a radio signal transmitted by the terminal apparatus.

A base station device according to one aspect of the present invention is a base station apparatus comprising: a notification unit configured to notify another base station apparatus of information indicating an instruction instructing that a random-access preamble transmitted by a terminal apparatus be measured for measuring a position of the terminal apparatus and a sequence to be used for transmission of the random-access preamble; an instruction unit configured to designate the sequence and instruct the terminal apparatus to transmit the random-access preamble; and a measurement unit configured to measure the random-access preamble transmitted by the terminal apparatus, using the sequence in order to measure the position of the terminal apparatus, wherein the position of the terminal apparatus is estimated based on results of measurement of the random-access preamble performed by the base station apparatus and the other base station apparatus.

A base station device according to another aspect of the present invention is a base station apparatus comprising: a receiving unit configured to receive, from another base station apparatus, information indicating an instruction instructing that a random-access preamble transmitted by a terminal apparatus be measured for measuring a position of the terminal apparatus and a sequence to be used for transmission of the random-access preamble; and a measurement unit configured to measure the random-access preamble transmitted by the terminal apparatus, using the sequence in order to measure the position of the terminal apparatus, in response to the instruction being received, wherein the position of the terminal apparatus is estimated based on results of measurement of the random-access preamble performed by the base station apparatus and the other base station apparatus.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram showing a configuration example of a wireless communication system;

FIG. 2 is a diagram showing an exemplary hardware configuration of an apparatus;

FIG. 3 is a diagram showing an exemplary functional configuration of a base station apparatus connected to a terminal apparatus;

FIG. 4 is a diagram showing an exemplary functional configuration of a base station apparatus that is not connected to a terminal apparatus;

FIG. 5 is a diagram showing an exemplary functional configuration of a terminal apparatus; and

FIG. 6 is a diagram showing an example of a flow of processing that is executed in the wireless communication system.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### System Configuration

FIG. 1 shows a configuration example of a wireless communication system according to the present embodiment. The wireless communication system may be, for example, a cellular communication system that includes base station apparatuses 101 to 103 and a terminal apparatus 111. The terminal apparatus 111 can receive a wireless communication service by being connected to one of the base station apparatuses 101 to 103. Note that the cellular communication system is configured in compliance with an existing standard of LTE (long term evolution), 5G (fifth generation), or the like, or a successor standard thereof, for example. In addition, assume that the base station apparatuses 101 to 103 have established time synchronization with each other, for example, by adjusting the time based on radio waves from the GPS (global positioning system), and frame timings of the base station apparatuses 101 to 103 are aligned with each other.

In the present embodiment, a radio signal transmitted by the terminal apparatus 111 is measured by the base station apparatuses 101 to 103, and the position of the terminal apparatus 111 is estimated based on the measurement results. The base station apparatuses 101 to 103 measure the arrival directions and arrival timings of the radio signal when it arrives, for example. The base station apparatuses 101 to 103 then notify the measurement results to an apparatus that executes position estimation. Note that the apparatus that executes position estimation may be one of the base station apparatuses 101 to 103, or may be prepared as an apparatus other than the base station apparatuses 101 to 103. Note that position estimation may be performed by a conventional technology that is based on arrival directions and an arrival time difference among three of more base station apparatuses, for example.

In order for the base station apparatuses 101 to 103 to accurately receive a radio signal from the terminal apparatus 111, deviation of the receiving timings of the radio signal from the subframe timings of the base station apparatuses 101 to 103 needs to be within a certain range. That is to say, in the OFDM (orthogonal frequency division multiplexing)-based system, in order to mitigate the influence of delayed waves, a signal in which a CP (cyclic prefix) is added to an OFDM symbol is transmitted, but a radio signal that arrives such that the length of the CP is exceeded cannot be accurately received.

The terminal apparatus 111 adjusts the transmission timing of a radio signal using a TA (timing advance) value instructed by the base station apparatus 101, for example, such that the radio signal is received by the base station apparatus 101 connected thereto at the timing of the beginning of a subframe. The radio signal transmitted at this timing arrives at the base station apparatus 101 at a timing when it can be accurately received, while it arrives at the base station apparatuses 102 and 103 with delays depending on distances. Here, for example, as shown in FIG. 1, if the distance between the terminal apparatus 111 and the base station apparatus 101 is significantly shorter compared to the distances between the terminal apparatus 111 and the base station apparatuses 102 and 103, timings at which the radio signal arrives at the base station apparatuses 102 and 103 may significantly delay. If the magnitude of this delay exceeds the length of the CP, the base station apparatuses 102 and 103 cannot accurately receive this radio signal. If SCS (subcarrier spacing) is 30 kHz, the length of the CP in an SRS (sounding reference signal) transmitted by the terminal apparatus 111 is 2.34 microsecond, for example. With this length of the CP, if the difference between the distance between the terminal apparatus 111 and the base station apparatus 101 and the distance between the terminal apparatus 111 and the base station apparatus 102 or the base station apparatus 103 is larger than or equal to 700 meters, the magnitude of the delay exceeds the length of the CP. For this reason, in a situation in which there is such a distance difference, if the position of the terminal apparatus 111 is estimated using an SRS, the estimation accuracy decreases.

In the present embodiment, in light of such circumstances, it is possible to execute position measurement using a random-access preamble (hereinafter, may be referred to as an “RA preamble”) with a longer guard time compared with the length of the CP of the SRS or the like. By using an RA preamble, even if the difference between the distance between the terminal apparatus 111 and the base station apparatus 101 and the distance between the terminal apparatus 111 and the base station apparatus 102 or the base station apparatus 103 is large, the position of the terminal apparatus 111 can be accurately estimated. Note that it is envisioned that, when an RA preamble is used, the base station apparatuses 101 to 103 cannot specify whether or not the RA preamble was transmitted by the terminal apparatus 111. For this reason, in the present embodiment, a non-contention-based RA preamble used at the time of a handover is reused. Specifically, as with a case where, at the time of a handover, identification information (ID) for designating a sequence of an RA preamble is notified from a base station apparatus that is a handover source to a terminal apparatus and a base station apparatus that is a handover destination, a similar ID is notified from the base station apparatus connected to the terminal apparatus in the present embodiment. The base station apparatus 101 notifies information such as an ID with which the sequence of the RA preamble can be specified, to the terminal apparatus 111 connected to the base station apparatus 101, and the base station apparatuses 102 and 103 involved with measurement for estimating the position of the terminal apparatus 111, for example. Note that a base station apparatus involved with measurement for estimating the position of the terminal apparatus 111 may be a base station apparatus adjacent to the base station apparatus 101 that forms a cell in which the terminal apparatus 111 is located, for example. Accordingly, for example, the base station apparatus 101 may specify base station apparatuses that form cells included in an adjacent cell list, and are to be notified of the information, as base station apparatuses involved with estimation of the position of the terminal apparatus 111, and perform notification of information for measurement of the RA preamble.

Note that the base station apparatus 101 may perform notification that the RA preamble is to be transmitted to the base station apparatuses involved with estimation of the position of the terminal apparatus 111, in order to perform position estimation. Specifically, the base station apparatuses involved with estimation of the position of the terminal apparatus 111 may be notified that the RA preamble is to be transmitted not only for a normal handover but for position estimation, and measurement for position measurement, namely measurement of the arrival direction, the arrival timing, and the like of the RA preamble needs to be performed. The base station apparatus 101 notifies information regarding a resource with which the RA preamble is to be transmitted and information such as a transmission timing, to the base station apparatuses involved with estimation of the position of the terminal apparatus 111, in addition to information with which the sequence of the RA preamble can be specified such as that described above. That is to say, since the terminal apparatus 111 does not transmit the RA preamble in order to perform a handover, the terminal apparatus 111 may transmit the RA preamble with a resource different from resources for the RA preamble in the base station apparatuses involved with estimation of the position of the terminal apparatus 111. For this reason, the base station apparatus 101 may designate a resource with which the RA preamble is to be transmitted (for example, a resource for the RA preamble in the base station apparatus 101 or a separately prepared dedicated resource), instruct the terminal apparatus 111 to transmit the RA preamble, and, furthermore, also notify the resource to the base station apparatuses involved with estimation of the position of the terminal apparatus 111.

Note that an instruction is transmitted from the base station apparatus 101 to the terminal apparatus 111 using an RRC (radio resource control) message, and information may be provided from the base station apparatus 101 to the base station apparatuses 102 and 103 using an interface that enables communication between base station apparatuses such as an Xn interface or NG interface.

After that, the terminal apparatus 111 generates an RA preamble using the sequence corresponding to the instructed ID, and transmits the RA preamble using the designated resource. Not only the base station apparatus 101, but also the base station apparatuses 102 and 103 then execute measurement for position estimation, namely measurement of the arrival directions, the arrival timings, and the like of the RA preamble. The base station apparatuses 101 to 103 then notify the measurement results to an apparatus that executes estimation of the position of the terminal apparatus 111. By adopting this configuration, the length of the guard time is sufficiently long compared to the length of the CP of the SRS or the like, and thus, even in a case where the diffidence between the distance between the terminal apparatus 111 and the base station apparatus 101 and the distance between the terminal apparatus 111 and the base station apparatus 102 or the base station apparatus 103 is large, the base station apparatuses 102 and 103 can accurately receive the radio signal from the terminal apparatus 111. Also, by the radio signal being accurately received, it is possible to improve the accuracy in estimation of the position of the terminal apparatus 111.

In addition, if the terminal apparatus 111 transmits the RA preamble with transmission power that is used when transmitting a signal to the base station apparatus 101, it may be envisioned that the base station apparatuses 102 and 103 cannot receive the RA preamble with sufficient power. For this reason, the base station apparatus 101 may give an instruction on transmission power for the terminal apparatus 111 to transmit the RA preamble such that the base station apparatuses 102 and 103 can receive the RA preamble with sufficient power. The base station apparatus 101 may instruct the terminal apparatus 111 to transmit the RA preamble for position estimation with maximum transmission power, for example. This enables nearby base station apparatuses involved with estimation of the position of the terminal apparatus 111 to reliably detect the RA preamble. In addition, the base station apparatus 101 causes the terminal apparatus 111 to measure the radio quality of radio signals transmitted from the nearby base station apparatuses to the terminal apparatus 111, and obtains a measurement result, for example. The base station apparatus 101 may instruct the terminal apparatus 111 to transmit an MR (measurement report), for example. The base station apparatus 101 transmits this instruction to the terminal apparatus 111 using an RRC message, for example. In addition, the base station apparatus 101 may set an event A4 that triggers transmission of an MR, for example, on a condition that the radio quality of an adjacent cell exceeds a predetermined threshold. Note that the radio quality that is used here may be, for example, values with which propagation loss can be can identified, such as RSRP (reference signal received power). Note that this is exemplary, and any radio quality based on which transmission power can be determined may be used.

Upon receiving the MR, the base station apparatus 101 may determine transmission power to be used by the terminal apparatus 111, based on values in the MR, and instruct the terminal apparatus 111 to transmit the RA preamble using the determined transmission power. This enables the RA preamble transmitted by the terminal apparatus 111 to reach base station apparatuses that are to measure the RA preamble, with sufficient power. In addition, the base station apparatus 101 may notify the terminal apparatus 111 of information for designating the number of times the transmission power is ramped up such that the RA preamble reaches the base station apparatuses that are to measure the RA preamble, with sufficient power. In a case where the transmission power increases by a predetermined level as a result of ramp-up being performed once, for example, the base station apparatus 101 may determine the number of times of ramp-up by dividing, by the predetermined level, a value obtained by subtracting the current transmission power from target transmission power. Note that information for designating transmission power and information for designating the number of times of ramp-up may each be newly defined as an information element in the RRC message that instructs transmission of the RA preamble. Information such as “preambleTransPowerForPositioning” may be defined as information for designating transmission power for the RA preamble for position estimation, for example. Also, information such as “preambleTransRampNum” may be defined as information for designating the number of times of ramp-up of the RA preamble. Note that, conventionally, “preambleTransMax” is already defined as the maximum value of the number of times of ramp-up, but a value different from this, for example, information such as “preambleTransRampNum” may be defined.

As described above, by using the RA preamble received from the terminal apparatus 111, as a radio signal for position estimation, and in addition, by designating transmission power as necessary, base station apparatuses located near the terminal apparatus 111 can accurately receive the radio signal. As a result, such base station apparatuses can accurately specify the arrival directions and arrival timings of the radio signal transmitted from the terminal apparatus 111, and the position of the terminal apparatus 111 can be accurately estimated.

### Apparatus Configuration

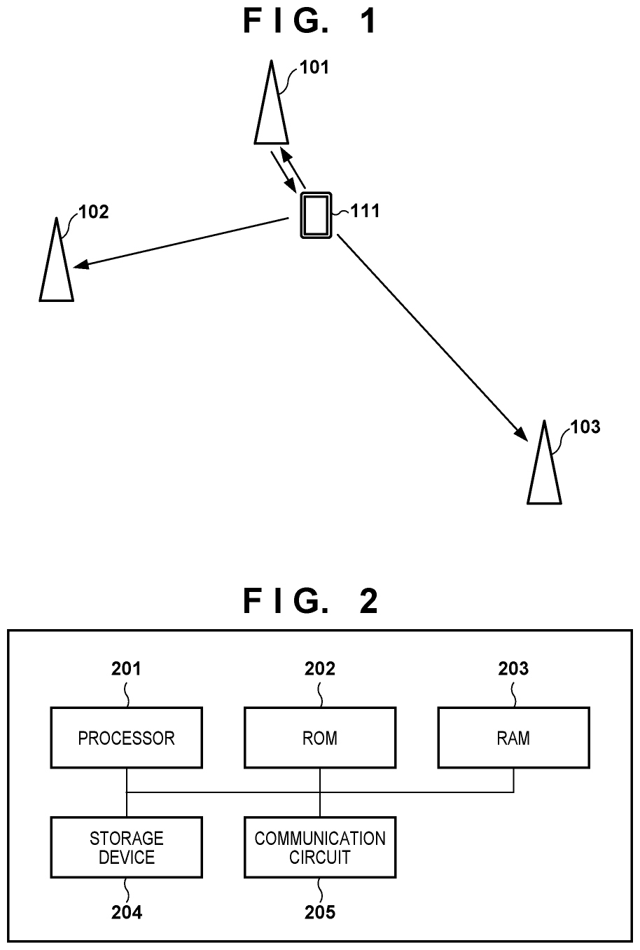

FIG. 2 is a diagram showing an exemplary hardware configuration of the base station apparatuses and the terminal apparatus. In an example, the base station apparatuses and the terminal apparatus each include a processor 201, a ROM 202, a RAM 203, a storage device 204, and a communication circuit 205. The processor 201 is a computer that includes one or more processing circuits, such as a general-purpose CPU (central processing unit) and an ASIC (application specific integrated circuit), and executes overall processing of the apparatus and above-described processing by reading and executing a program stored in the ROM 202 or the storage device 204. The ROM 202 is a read-only memory that stores information such as programs, various parameters, and the like related to processing that is executed by the base station apparatus or the terminal apparatus. The RAM 203 is a random-access memory that functions as a workspace when the processor 201 executes a program, and stores temporary information. The storage device 204 is constituted by a detachable external storage device, for example. The communication circuit 205 is constituted by a circuit for wireless communication that complies with a cellular communication standard of LTE or 5G, or a successor thereof, for example. Note that FIG. 2 illustrates one communication circuit 205, but the base station apparatuses and the terminal apparatus may each include a plurality of communication circuits. The base station apparatuses and the terminal apparatus may each include a plurality of wireless communication circuits and antennas for the LTE standard, the 5G standard, a successor standard thereof, and the like, respectively. In addition, the base station apparatus may include a communication circuit 205 for wired or wireless communication with other base station apparatuses, for example, and the terminal apparatus may include a communication circuit 205 that complies with a wireless communication standard other than a cellular communication standard such as a wireless LAN and Bluetooth (registered trademark).

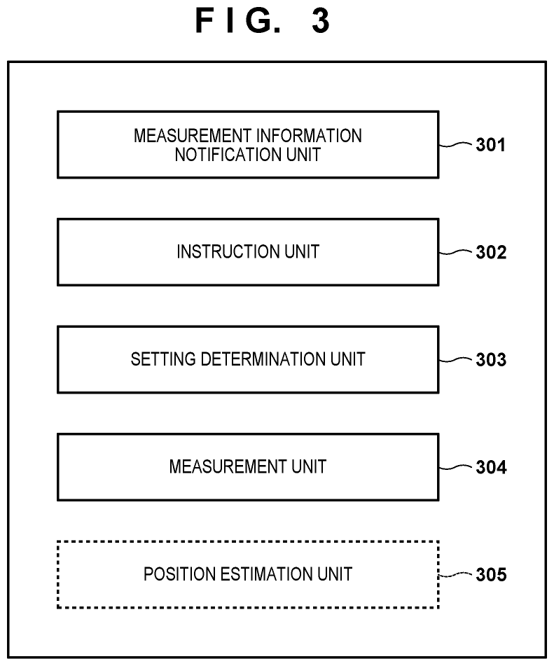

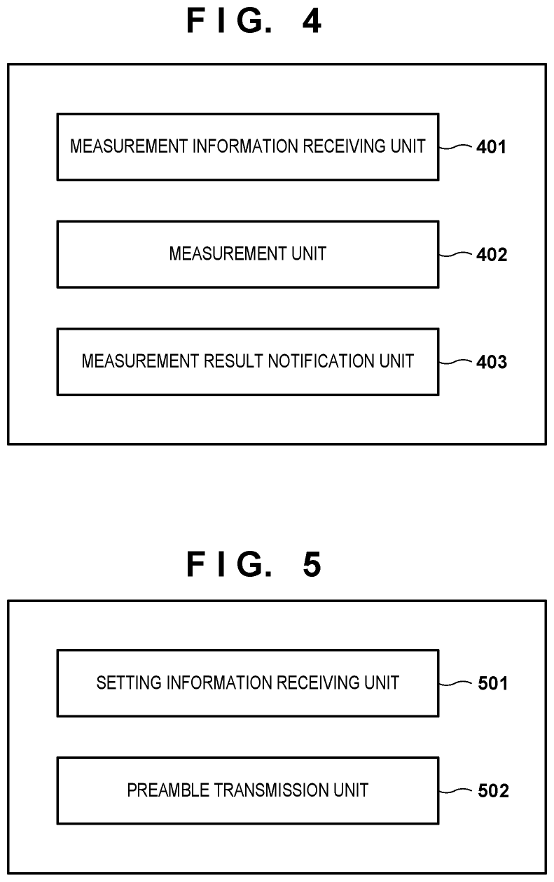

FIG. 3 is a diagram showing an exemplary functional configuration of a base station apparatus (for example, the base station apparatus 101) connected to a terminal apparatus. Note that, in a case where this base station apparatus performs measurement for estimating the position of a terminal apparatus connected to another base station apparatus, for example, the base station apparatus may further include the functions in FIG. 4 to be described later. The base station apparatus includes, for example, a measurement information notification unit 301, an instruction unit 302, a setting determination unit 303, and a measurement unit 304. In addition, the base station apparatus may include a position estimation unit 305, for example, in a case where the base station apparatus executes processing for estimating the position of the terminal apparatus by itself. Note that these functional units can be implemented, for example, by the processor 201 executing a program stored in the ROM 202 or the storage device 204. Note that there is no limitation thereto, and, for example, some or all of these functional units may be implemented using dedicated hardware. Note that FIG. 3 only shows functions related to the present embodiment for ease of description, and the base station apparatus may have functions of a base station apparatus that complies with a standard of LTE or 5G, or a successor thereof, for example, as a matter of course. Processing that is to be executed by the base station apparatus connected to the terminal apparatus has been described above as processing that is performed by the base station apparatus 101, and thus, here, the functional configuration thereof is only outlined briefly.

The measurement information notification unit 301 notifies another base station apparatus that is not connected to the terminal apparatus, of information indicating that measurement of the RA preamble for estimating the position of the terminal apparatus needs to be executed, an ID indicating the sequence of the RA preamble, and information indicating a resource with which the RA preamble is to be transmitted. The instruction unit 302 transmits, to the terminal apparatus, information for instructing transmission of the RA preamble for position estimation along with the ID indicating the sequence to be used and information indicating the resource.

The setting determination unit 303 determines settings to be used when the terminal apparatus transmits the RA preamble. The setting determination unit 303 selects a sequence of an RA preamble from sequences that can be used in a non-contention-based random-access procedure, for example. Note that a sequence used for position estimation may be prepared as a sequence that is not used in a case of a handover. In this case, the above measurement information notification unit 301 may implicitly perform notification that the measurement of the RA preamble for estimating the position of the terminal apparatus needs to be executed, by notifying the ID for designating the sequence to be used for position estimation. That is to say, the measurement information notification unit 301 does not need to explicitly perform notification that measurement of the RA preamble, namely measurement for estimating the position of the terminal apparatus needs to be executed. In addition, the setting determination unit 303 may determine a resource for transmitting the RA preamble. The setting determination unit 303 may further determine transmission power to be used when the terminal apparatus transmits the RA preamble for position estimation and the number of times of ramp-up. In an example, the setting determination unit 303 may execute setting of transmission of a message for causing the terminal apparatus to transmit an MR and an event. The setting determination unit 303 may then receive, from the terminal apparatus, the measurement result of the radio quality of signals from the nearby base station apparatuses, and determine transmission power and the number of times of ramp-up based on the measurement result. In addition, the setting determination unit 303 may determine that the RA preamble needs to be transmitted with the maximum transmission power of the terminal apparatus. Note that the settings determined by the setting determination unit 303 are notified to the other base station apparatuses and the terminal apparatus by the measurement information notification unit 301 and the instruction unit 302.

The measurement unit 304 measures the RA preamble for estimating the position of the terminal apparatus transmitted from the terminal apparatus, based on the settings for measurement determined by the setting determination unit 303. The measurement unit 304 specifies the RA preamble of the sequence corresponding to the above ID, as an RA preamble transmitted from the terminal apparatus, and specifies the arrival direction and arrival timing of the RA preamble, for example. The position estimation unit 305 estimates the position of the terminal apparatus based on the arrival direction and arrival timing specified by the measurement unit 304 and information indicating an arrival direction and arrival timing received from another base station apparatus. Note that, in a case where position estimation processing is performed by another apparatus, the measurement unit 304 notifies the apparatus of the specified arrival direction and arrival timing. In this case, the position estimation unit 305 may be omitted.

FIG. 4 is a diagram showing an exemplary functional configuration of a base station apparatus that executes measurement for estimating the position of a terminal apparatus that is not connected to the base station apparatus (for example, the base station apparatuses 102 and 103). Note that, in a case where this base station apparatus performs measurement for estimating the position of a terminal apparatus connected to the base station apparatus, for example, the base station apparatus may further have the above function in FIG. 3. The base station apparatus includes a measurement information receiving unit 401, a measurement unit 402, and a measurement result notification unit 403. Although not illustrated, in a case where the base station apparatus executes processing for estimating the position of the terminal apparatus by itself, for example, the base station apparatus may have a function equivalent to the above position estimation unit 305. Note that these functional units may be implemented, for example, by the processor 201 executing a program stored in the ROM 202 or the storage device 204. Note that there is no limitation thereto, and, for example, some or all of these functional units may be implemented using dedicated hardware. Note that FIG. 4 only shows functions related to the present embodiment for ease of description, and the base station apparatus may have functions of a base station apparatus that complies with a standard of LTE or 5G, or a successor thereof, for example, as a matter of course. Processing that is performed by a base station apparatus that executes estimation of the position of a terminal apparatus that is not connected thereto has been described above as processing that is performed by the base station apparatuses 102 and 103, and thus, here, the functional configuration thereof is only outlined briefly.

The measurement information receiving unit 401 receives information for receiving an RA preamble transmitted from a terminal apparatus, in order to estimate the position of the terminal apparatus, from a base station apparatus connected to the terminal apparatus. The measurement information receiving unit 401 receives information indicating that an RA preamble for estimating the position of the terminal apparatus needs to be measured, an ID indicating the sequence of the RA preamble, and information indicating a resource with which the RA preamble is to be transmitted, from another base station apparatus connected to the terminal apparatus. The measurement unit 402 measures the RA preamble for estimating the position of the terminal apparatus transmitted from the terminal apparatus based on the information for measurement received by the measurement information receiving unit 401. The measurement unit 402 specifies the RA preamble of the sequence corresponding to the above ID as an RA preamble transmitted from the terminal apparatus, and specifies the arrival direction and arrival timing of the RA preamble, for example. The measurement result notification unit 403 notifies information indicating the arrival direction and arrival timing measured by the measurement unit 402, to an apparatus that executes position estimation. Note that, for example, in a case where the base station apparatus has a function corresponding to the above position estimation unit 305, due to the function, the base station apparatus may obtain information regarding the arrival direction and arrival timing of the RA preamble from another base station apparatus, and estimate the position of the terminal apparatus.

FIG. 5 is a diagram showing an exemplary functional configuration of a terminal apparatus (for example, the terminal apparatus 111). The terminal apparatus includes, for example, a setting information receiving unit 501 and a preamble transmission unit 502. Note that these functional units may be implemented, for example, by the processor 201 executing a program stored in the ROM 202 or the storage device 204. Note that there is no limitation thereto, and, for example, some or all of these functional units may be implemented using dedicated hardware. Note that FIG. 5 only shows functions related to the present embodiment for ease of description, and the terminal apparatus may have functions of a terminal apparatus that complies with a standard of LTE or 5G, or a successor thereof, for example, as a matter of course. Processing that is performed by the terminal apparatus has been described above as processing that is performed by the terminal apparatus 111, and thus, here, the functional configuration thereof is only outlined briefly.

The setting information receiving unit 501 receives information for instructing transmission of an RA preamble for position estimation along with information indicating an ID indicating a sequence to be used and a resource to be used, from a base station apparatus connected to the terminal apparatus. In addition, the setting information receiving unit 501 may further receive information indicating transmission power from the base station apparatus connected to the terminal apparatus. The preamble transmission unit 502 generates and transmits an RA preamble based on the information received by the setting information receiving unit 501. Specifically, the preamble transmission unit 502 generates an RA preamble using the sequence corresponding to the notified ID, and transmits the RA preamble using the designated resource. In addition, when transmission power is designated, the preamble transmission unit 502 may transmit the RA preamble with the designated transmission power. Note that the terminal apparatus has, as functions of a normal terminal apparatus, a function for measuring the radio quality of a radio signal transmitted from a nearby base station apparatus and a function for transmitting an MR that includes the measurement result to a base station apparatus connected thereto, as a matter of course.

### Flow of Processing

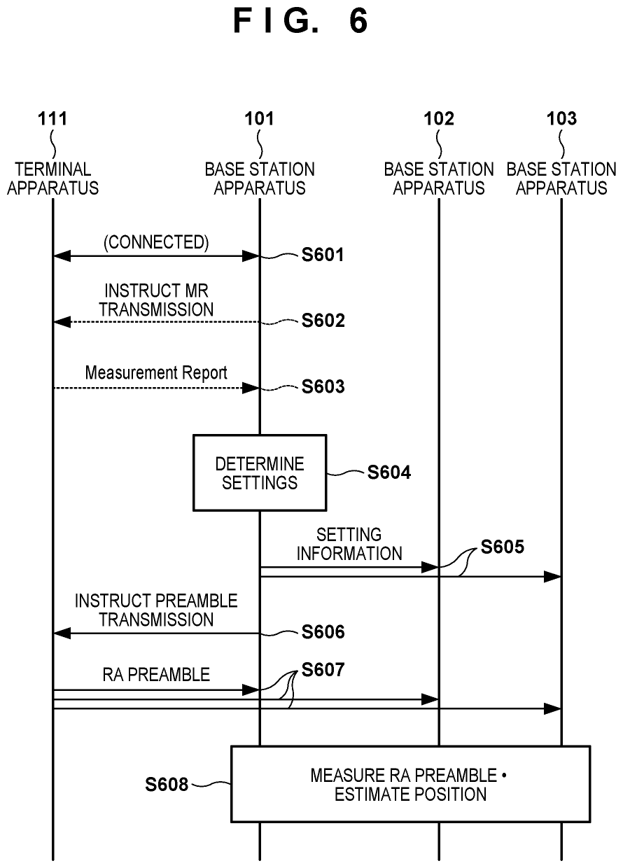

Next, an example of a flow of processing that is executed in a wireless communication system will be described with reference to FIG. 6. Here, assume that, in a wireless communication system such as that shown in FIG. 1, the terminal apparatus 111 is connected to the base station apparatus 101 (step S601). In a case where setting has been performed in this state such that position estimation is performed in accordance with an instruction from a network or at a predetermined time interval, for example, when a time at which the estimation is to be performed comes, the base station apparatus 101 determines that estimation of the position of the terminal apparatus 111 is to be performed. In this case, the base station apparatus 101 determines transmission settings of an RA preamble for estimating the position of the terminal apparatus 111 (step S604). The base station apparatus 101 determines, for example, a sequence to be used when the terminal apparatus 111 generates an RA preamble and a resource to be used when the terminal apparatus 111 transmits the RA preamble. In addition, the base station apparatus 101 may determine settings related to transmission power for the RA preamble. As an example, the base station apparatus 101 may determine that the RA preamble is to be transmitted with the maximum transmission power. In addition, the base station apparatus 101 may determine transmission power and the number of times of ramp-up in accordance with the radio quality (propagation loss) between the terminal apparatus 111 and the base station apparatus 102 or the base station apparatus 103. In this case, the base station apparatus 101 instructs transmission of an MR or notifies the terminal apparatus 111 of settings of an event for transmitting the MR, for example (step S602). The base station apparatus 101 may then receive the MR from the terminal apparatus 111 (step S603), and determine transmission power and the number of times of ramp-up to be used for transmission of the RA preamble, based on the measurement result of the radio quality.

The base station apparatus 101 notifies the base station apparatuses 102 and 103 of setting information that includes information regarding an ID indicating the sequence of the RA preamble that is transmitted by the terminal apparatus 111, a frequency at which the RA preamble is to be transmitted and a time resource on which the RA preamble is to be transmitted (step S605). Note that this setting information may include information indicating that the RA preamble for estimating the position of the terminal apparatus 111 needs to be measured. Note that, in a case where an ID of a sequence that can be used only for an RA preamble for position estimation has been prepared, notification of the ID of the sequence that can be used only for the RA preamble as an ID of a sequence of an RA preamble may implicitly indicate that the RA preamble needs to be measured to estimate the position of the terminal apparatus 111. In addition, the base station apparatus 101 notifies the terminal apparatus 111 of information for instructing that the RA preamble for estimating the position of the terminal apparatus 111 be transmitted (step S606). At this time, the base station apparatus 101 may notify the terminal apparatus 111 of the ID corresponding to the sequence to be used for the terminal apparatus 111 to generate an RA preamble, and information regarding the frequency at which the RA preamble is to be transmitted and the time resource on which the RA preamble is to be transmitted. In addition, the base station apparatus 101 may notify the terminal apparatus 111 of information related to the transmission power for the RA preamble.

The terminal apparatus 111 generates an RA preamble using the sequence corresponding to the designated ID, in response to the instruction being received in step S606, and transmits the RA preamble using the designated frequency and time resource (step S607). The base station apparatus 101 then measures the arrival direction and arrival timing of the RA preamble transmitted from the terminal apparatus 111 using the settings determined in step S604 (step S608). In addition, the base station apparatuses 102 and 103 measure the arrival directions and arrival timings of the RA preamble transmitted from the terminal apparatus 111 based on the setting information received in step S605 (step S608). The arrival directions and arrival timings measured by the base station apparatuses 101 to 103 are then provided to an apparatus that executes processing for estimating the position of the terminal apparatus 111 such as the base station apparatus 101, and the position of the terminal apparatus 111 is estimated by the apparatus (not illustrated).

By adopting the above configuration, a base station apparatus located near the terminal apparatus 111 can accurately specify an arrival direction and an arrival timing of a radio signal transmitted from the terminal apparatus 111, and accurately estimate the position of the terminal apparatus 111. This makes it possible to contribute to Goal 9 of Sustainable Development Goals (SDGs) lead by the United Nations, which aims to “build resilient infrastructure, promote sustainable industrialization, and foster innovation.

According to the present invention, it is possible to accurately estimate the position of a terminal apparatus based on a radio signal transmitted by the terminal apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A base station apparatus comprising:
a notification unit configured to notify another base station apparatus of information indicating an instruction instructing that a random-access preamble transmitted by a terminal apparatus be measured for measuring a position of the terminal apparatus and a sequence to be used for transmission of the random-access preamble;
an instruction unit configured to designate the sequence and instruct the terminal apparatus to transmit the random-access preamble; and
a measurement unit configured to measure the random-access preamble transmitted by the terminal apparatus, using the sequence in order to measure the position of the terminal apparatus,
wherein the position of the terminal apparatus is estimated based on results of measurement of the random-access preamble performed by the base station apparatus and the other base station apparatus.

2. The base station apparatus according to claim 1,
wherein the instruction unit further transmits, to the terminal apparatus, an instruction on transmission power for transmitting the random-access preamble.

3. The base station apparatus according to claim 2,
wherein the instruction on transmission power is an instruction instructing that the random-access preamble be transmitted with maximum transmission power of the terminal apparatus.

4. The base station apparatus according to claim 2, further comprising
an obtaining unit configured to obtain a result of measurement of radio quality of a signal from the other base station apparatus, performed by the terminal apparatus,
wherein the instruction on transmission power is an instruction instructing that the random-access preamble be transmitted with power that is based on propagation loss corresponding to the radio quality.

5. The base station apparatus according to claim 2, further comprising
an obtaining unit configured to obtain a result of measurement of radio quality of a signal from the other base station apparatus, performed by the terminal apparatus,
wherein the instruction on transmission power is an instruction indicating the number of times the transmission power is ramped up based on propagation loss corresponding to the radio quality.

6. The base station apparatus according to claim 1, further comprising:
an obtaining unit configured to obtain a result of measurement of the random-access preamble performed by the other base station apparatus; and
an estimation unit configured to estimate the position of terminal apparatus based on results of measurement of the random-access preamble performed by the base station apparatus and the other base station apparatus.

7. A base station apparatus comprising:
a receiving unit configured to receive, from another base station apparatus, information indicating an instruction instructing that a random-access preamble transmitted by a terminal apparatus be measured for measuring a position of the terminal apparatus and a sequence to be used for transmission of the random-access preamble; and
a measurement unit configured to measure the random-access preamble transmitted by the terminal apparatus, using the sequence in order to measure the position of the terminal apparatus, in response to the instruction being received,
wherein the position of the terminal apparatus is estimated based on results of measurement of the random-access preamble performed by the base station apparatus and the other base station apparatus.

8. The base station apparatus according to claim 7, further comprising:
an obtaining unit configured to obtain a result of measurement of the random-access preamble performed by the other base station apparatus; and
an estimation unit configured to estimate the position of the terminal apparatus based on results of measurement of the random-access preamble performed by the base station apparatus and the other base station apparatus.

9. A control method executed by a base station apparatus, comprising:
notifying another base station apparatus of information indicating an instruction instructing that a random-access preamble transmitted by a terminal apparatus be measured for measuring a position of the terminal apparatus and a sequence to be used for transmission of the random-access preamble;
designating the sequence and instructing the terminal apparatus to transmit the random-access preamble; and
measuring the random-access preamble transmitted by the terminal apparatus, using the sequence in order to measure the position of the terminal apparatus,
wherein the position of the terminal apparatus is estimated based on results of measurement of the random-access preamble performed by the base station apparatus and the other base station apparatus.

10. A control method executed by a base station apparatus, comprising:
receiving, from another base station apparatus, information indicating an instruction instructing that a random-access preamble transmitted by a terminal apparatus be measured for measuring a position of the terminal apparatus and a sequence to be used for transmission of the random-access preamble; and
measuring the random-access preamble transmitted by the terminal apparatus, using the sequence in order to measure the position of the terminal apparatus, in response to the instruction being received,
wherein the position of the terminal apparatus is estimated based on results of measurement of the random-access preamble performed by the base station apparatus and the other base station apparatus.

11. A non-transitory computer-readable storage medium that stores a program for causing a computer included in a base station apparatus to:
notify another base station apparatus of information indicating an instruction instructing that a random-access preamble transmitted by a terminal apparatus be measured for measuring a position of the terminal apparatus and a sequence to be used for transmission of the random-access preamble;
designate the sequence and instruct the terminal apparatus to transmit the random-access preamble; and
measure the random-access preamble transmitted by the terminal apparatus, using the sequence in order to measure the position of the terminal apparatus,
wherein the position of the terminal apparatus is estimated based on results of measurement of the random-access preamble performed by the base station apparatus and the other base station apparatus.

12. A non-transitory computer-readable storage medium that stores a program for causing a computer included in a base station apparatus to:
receive, from another base station apparatus, information indicating an instruction instructing that a random-access preamble transmitted by a terminal apparatus be measured for measuring a position of the terminal apparatus and a sequence to be used for transmission of the random-access preamble; and
measure the random-access preamble transmitted by the terminal apparatus, using the sequence in order to measure the position of the terminal apparatus, in response to the instruction being received,
wherein the position of the terminal apparatus is estimated based on results of measurement of the random-access preamble performed by the base station apparatus and the other base station apparatus.
